(19) United States
(12) Patent Application Publication
(10) Pub. No.: US 2018/0165525 A1
(43) Pub. Date: Jun. 14, 2018

(54) TRAVELING LANE DETERMINING DEVICE AND TRAVELING LANE DETERMINING METHOD

(71) Applicant: MITSUBISHI ELECTRIC CORPORATION, Tokyo (JP)

(72) Inventors: Yuji HAMADA, Tokyo (JP); Masahiko IKAWA, Tokyo (JP); Masatoshi FUJII, Tokyo (JP); Norihiro NISHIUMA, Tokyo (JP)

(73) Assignee: MITSUBISHI ELECTRIC CORPORATION, Tokyo (JP)

(21) Appl. No.: 15/577,687

(22) PCT Filed: Jun. 15, 2015
(86) PCT No.: PCT/JP2015/067153

§ 371 Date: Nov. 28, 2017

(51) Int. Cl. G06K 9/00; G01C 21/30; G08G 1/16

(52) U.S. Cl. CPC G06K 9/00798; G08G 1/167; G01C 21/30

(57) ABSTRACT

In the present invention, a traveling lane on which a vehicle is traveling is estimated by a traveling lane estimator based on map information, current position information of the vehicle, and white line information on a white line that divides a road on which the vehicle travels. The traveling lane estimator estimates the traveling lane based on a traveling lane probability of each of lanes, which is obtained based on a line type of the white line, a traveling lane probability of each of the lanes, which is obtained based on whether or not a lane adjacent to the traveling lane is present, and a traveling lane probability of each of the lanes, which is obtained based on a lane on which the vehicle traveled when the traveling lane was estimated previously.

### TECHNICAL FIELD

The present invention relates to a traveling lane determining device and a traveling lane determining method, which determine a traveling lane as a lane on which a vehicle is traveling.

### BACKGROUND ART

Technologies for determining a traveling lane as a lane on which a vehicle is traveling are used in a case of specifying a current position of the vehicle in a car navigation device, a locator or the like. For example, a surrounding environment such as a traveling lane of the vehicle and a curb stone is recognized by using a sensor including a camera, a laser radar and the like, whereby the current position of the vehicle is specified.

The technologies for determining the traveling lane of the vehicle are disclosed, for example, in Patent Documents 1 and 2. In the technologies disclosed in Patent Documents 1 and 2, the traveling lane of the vehicle is determined based on image information of an image captured by the camera and map information that indicates a map.

Specifically, a traveling lane recognizing device disclosed in Patent Document 1 is configured to determine which a broken line or a solid line a white line is, the white line being detected from image information of an image captured by a rear camera, by using the map information and the image information, and to thereby estimate on which a right end or left end of a road the traveling lane is.

Moreover, a traveling lane determining device disclosed in Patent Document 2 is configured to determine whether or not a white line pattern detected from an image captured by the camera coincides with a white line pattern, which is defined in advance, from the map and the image based on information on the white line pattern defined in advance, and to thereby determine the traveling lane.

### PRIOR ART DOCUMENTS

### Patent Documents

Patent Document 1: Japanese Patent Application Laid-Open No. 2008-276642

Patent Document 2: Japanese Patent Application Laid-Open No. 2005-004442

### SUMMARY OF INVENTION

### Problems to be Solved by the Invention

In the technologies disclosed in Patent Documents 1 and 2 mentioned above, information on a white line detected from an image captured in real time is used. There is no problem in a situation where the white line is detected with good accuracy; however, on a real road, the white line is not always detected due to accuracy of the camera and a density of the white line. When no white line is detected, there is an apprehension that the traveling lane cannot be specified accurately in the technologies disclosed in Patent Documents 1 and 2 mentioned above.

Hence, in the technologies disclosed in Patent Documents 1 and 2, there is a problem that the traveling lane of the vehicle cannot be determined stably.

It is an object of the present invention to provide a traveling lane determining device and a traveling lane determining method, which can stably determine the traveling lane of the vehicle.

### Means for Solving the Problems

A traveling lane determining device of the present invention is a traveling lane determining device that determines a traveling lane as a lane on which a vehicle is traveling among lanes which constitute a road, the traveling lane determining device including: a map information storage to store map information on a map including the road; a current position acquisition unit to acquire current position information on a current position of the vehicle; a white line information acquisition unit to acquire white line information on a white line that divides the road; a white line information storage to store the white line information; a traveling lane estimator to estimate the traveling lane on which the vehicle is traveling based on the map information, the current position information and the white line information; a traveling lane monitor to monitor the traveling lane estimated by the traveling lane estimator; and a traveling lane decision unit to decide the traveling lane based on a result of the estimation by the traveling lane estimator and a result of the monitoring by the traveling lane monitor, in which the traveling lane estimator estimates the traveling lane based on a probability that each of lanes, which constitutes the road, is the traveling lane, the probability being obtained based on a line type of the white line, a probability that each of the lanes is the traveling lane, the probability being obtained based on whether or not a lane adjacent to the traveling lane is present, and a probability that each of the lanes is the traveling lane, the probability being obtained based on a lane on which the vehicle traveled when the traveling lane was previously estimated.

A traveling lane determining method of the present invention is a traveling lane determining method for determining a traveling lane as a lane on which a vehicle is traveling among lanes which constitute a road, the traveling lane determining method including: acquiring current position information on a current position of the vehicle; acquiring white line information on a white line that divides the road; estimating the traveling lane on which the vehicle is traveling based on map information on a map including the road, the current position information and the white line information; monitoring the estimated traveling lane; and deciding the traveling lane based on a result of estimating the traveling lane and a result of monitoring the traveling lane, in which, at a time of estimating the traveling lane, the traveling lane determining method estimates the traveling lane based on a probability that each of lanes, which constitutes the road, is the traveling lane, the probability being obtained based on a line type of the white line, a probability that each of the lanes is the traveling lane, the probability being obtained based on whether or not a lane adjacent to the traveling lane is present, and a probability that each of the lanes is the traveling lane, the probability being obtained based on a lane on which the vehicle traveled when the traveling lane was previously estimated.

### Effects of the Invention

In accordance with the traveling lane determining device of the present invention, by the traveling lane estimator, the traveling lane is estimated based on the probability that each of the lanes is the traveling lane, the probability being obtained based on the line type of the white line, the probability that each of the lanes is the traveling lane, the probability being obtained based on whether or not the adjacent lane is present, and the probability that each of the lanes is the traveling lane, the probability being obtained based on the lane on which the vehicle traveled when the traveling lane was estimated previously. In this way, the traveling lane can be estimated with good accuracy. Moreover, when detection accuracy for the white line is relatively low, the traveling lane can be estimated by using any of the above-mentioned probabilities that each of the lanes is the traveling lane, and accordingly, estimation with relatively high robustness can be carried out. Hence, the traveling lane of the vehicle can be determined stably.

In accordance with the traveling lane determining device of the present invention, the traveling lane is estimated based on the probability that each of the lanes is the traveling lane, the probability being obtained based on the line type of the white line, the probability that each of the lanes is the traveling lane, the probability being obtained based on whether or not the adjacent lane is present, and the probability that each of the lanes is the traveling lane, the probability being obtained based on the lane on which the vehicle traveled when the traveling lane was estimated previously. In this way, the traveling lane can be estimated with good accuracy. Moreover, when detection accuracy for the white line is relatively low, the traveling lane can be estimated by using any of the above-mentioned probabilities that each of the lanes is the traveling lane, and accordingly, estimation with relatively high robustness can be carried out. Hence, the traveling lane of the vehicle can be determined stably.

Objects, features, aspects and advantages of the present invention will be more apparent by the following detailed description and the accompanying drawings.

### BRIEF DESCRIPTION OF DRAWINGS

FIG. 1 is a block diagram showing a configuration of a traveling lane determining device 1 in a first embodiment of the present invention.

FIG. 2 is a block diagram showing a hardware configuration of the traveling lane determining device 1 in the first embodiment of the present invention.

FIG. 3 is a view showing an example of a white line information acquirable range 30 by a white line information acquisition unit 13.

FIG. 4 is a view showing an example of a relationship between positions of vehicles and white lines.

FIG. 5 is a view showing another example of the relationship between the positions of the vehicles and the white lines.

FIG. 6 is a view showing an example of a relationship between the positions of the vehicles and the white lines when lane crossing occurs.

FIG. 7 is a view showing an example of detection positions of the white lines.

FIG. 8 is a view showing an example of the detection positions of the white lines, which are changed by the lane crossing.

FIG. 9 is a graph showing temporal changes of the detection positions of the white lines.

FIG. 10 is a table showing an example of a traveling lane probability list on a road with two lanes.

FIG. 11 is a table showing an example of a traveling lane probability list on a road with three lanes.

FIG. 12 is a table showing an example of a traveling lane probability list on a road with four lanes.

FIG. 13 is a table showing another example of the traveling lane probability list for use in a traveling lane estimator 14.

FIG. 14 is a flowchart showing a processing procedure with regard to lane change determination processing in the traveling lane determining device 1 of the first embodiment of the present invention.

FIG. 15 is a flowchart showing a processing procedure with regard to traveling lane estimation processing in the traveling lane determining device 1 of the first embodiment of the present invention.

FIG. 16 is a flowchart showing the processing procedure with regard to the traveling lane estimation processing in the traveling lane determining device 1 of the first embodiment of the present invention.

FIG. 17 is a flowchart showing a processing procedure with regard to identification processing for abnormal white line information in the traveling lane determining device 1 of the first embodiment of the present invention.

FIG. 18 is a block diagram showing a configuration of a traveling lane determining device 2 in a second embodiment of the present invention.

FIG. 19 is a flowchart showing a processing procedure with regard to position specifying processing in the traveling lane determining device 2 of the second embodiment of the present invention.

FIG. 20 is a block diagram showing a configuration of a traveling lane determining device 3 in a third embodiment of the present invention.

FIG. 21 is a flowchart showing a processing procedure with regard to error correction processing in the traveling lane determining device 3 of the third embodiment of the present invention.

### DESCRIPTION OF EMBODIMENTS

### First Embodiment

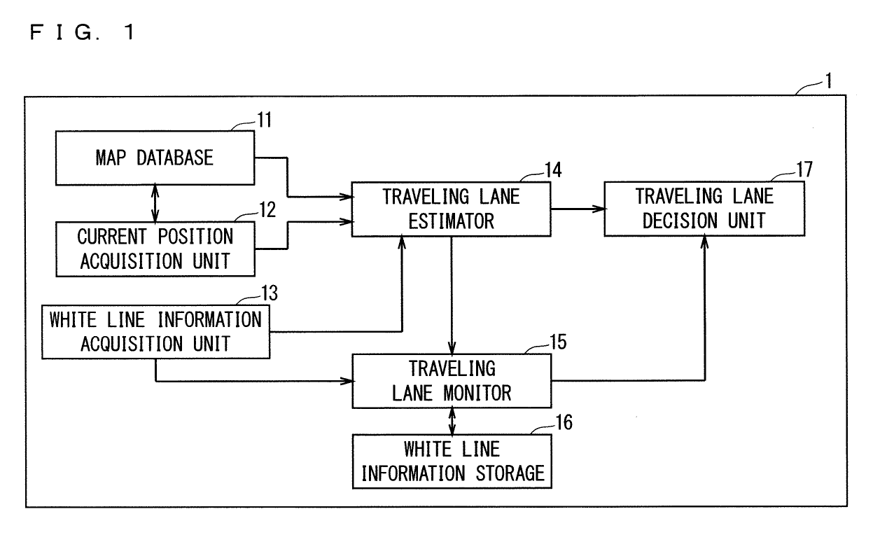

FIG. 1 is a block diagram showing a configuration of a traveling lane determining device 1 in a first embodiment of the present invention. The traveling lane determining device 1 of this embodiment is configured to be mountable on a vehicle, for example, an automobile. In this embodiment, the traveling lane determining device 1 is realized by a navigation device having a navigation function to guide a route. A traveling lane determining method as another embodiment of the present invention is executed by the traveling lane determining device 1 of this embodiment.

The traveling lane determining device 1 is configured by including a map database 11, a current position acquisition unit 12, a white line information acquisition unit 13, a traveling lane estimator 14, a traveling lane monitor 15, a white line information storage 16, and a traveling lane decision unit 17.

The map database 11 is realized by a storage device such as a hard disk drive (abbreviation: HDD) device and a semiconductor memory, for example. The map database 11 stores map information on a map. The map database 11 corresponds to a map information storage.

The map information is configured by hierarchizing a plurality of maps corresponding to predetermined scales. The map information includes: road information as information on roads; lane information as information on lanes which configure roads; and configuration line information as information on configuration lines which configure the lanes.

The road information includes information, for example, on shapes of the roads, latitudes and longitudes of the roads, curvatures of the roads, gradients of the roads, identifiers of the roads, the number of lanes of the roads, line types of the roads, and in addition, road attributes such as general roads, expressways and priority roads.

The lane information includes information, for example, on identifiers of lanes which configure the roads, latitudes and longitudes of the lanes, and in addition, center lines.

The configuration line information includes information on identifiers of respective lines which configure the lanes, latitudes and longitudes of the respective lines which configure the lanes, and in addition, line types and curvatures of the respective lines which configure the lanes. The road information is managed for each of the roads. The lane information and the configuration line information are managed for each of the lanes.

The map information is used for navigation, driving support, automatic driving, and the like. The map information may be updated via communication, or may be generated from white line information acquired by the white line information acquisition unit 13.

In this embodiment, the map database 11 is provided inside the traveling lane determining device 1, but may be provided outside the traveling lane determining device 1. For example, the map database 11 may be provided outside the vehicle on which the traveling lane determining device 1 is mounted, for example, in a server device outside the vehicle. In this case, the traveling lane determining device 1 is configured to acquire all or part of the map information from the map database, which is provided outside the vehicle, by communication. Specifically, the traveling lane determining device 1 is configured to acquire the map information, for example, from such a map database provided in the server device outside the vehicle via a communication network such as the Internet.

The current position acquisition unit 12 acquires current position information that indicates a current position of the vehicle on which the traveling lane determining device 1 is mounted. The current position information is indicated, for example, by any one or plurality of: a road link that indicates a road on which the vehicle is traveling; latitude and longitude of the current position; a road identifier as identification information of a road on the map, which is based on the map information; a lane identifier as identification information of the lane; a road attribute; in addition, a rectangular region including the current position of the map; and the like.

The current position acquisition unit 12 is configured, for example, of a Global Positioning System (abbreviation: GPS) sensor, a gyro sensor, a vehicle speed sensor and an acceleration sensor.

The current position acquisition unit 12 performs map matching with the map that is based on the map information, which is read out from the map database 11, by using the information detected by the GPS sensor, the gyro sensor, the vehicle speed sensor and the acceleration sensor, and thereby generates the current position information that indicates the current position.

The current position acquisition unit 12 may be configured to acquire the current position information from the hardware, which is provided outside the traveling lane determining device 1, via the communication network such as the Internet. The current position acquisition unit 12 gives the acquired current position information to the traveling lane estimator 14.

The white line information acquisition unit 13 is configured of a front camera provided so as to be capable of capturing a region in front of the vehicle in a traveling direction, a rear camera provided so as to be capable of capturing a region in the rear of the vehicle in the traveling direction, and sensors such as laser radars.

The white line information acquisition unit 13 captures the above-mentioned regions by using the front camera and the rear camera, thereby acquiring the white line information on white lines drawn on roads in the above-mentioned regions. Here, the white lines refer to dividing lines which divide a road, and include a roadway center line, a lane boundary line, and a roadway outside line. Moreover, the white lines include lines with colors other than white, for example, a yellow line.

The white line information includes information that indicates line types of the white lines, such as a solid line, a broken line, a double line and a yellow line, and in addition, information that indicates shapes of the white lines. The information that indicates the shapes of the white line is, for example, information in which each of the white lines is expressed by a function. The white line information may include information that indicates quality of the white lines. Moreover, the white line information may include information that indicates lengths of white lines of which white line information is usable as reliable ones.

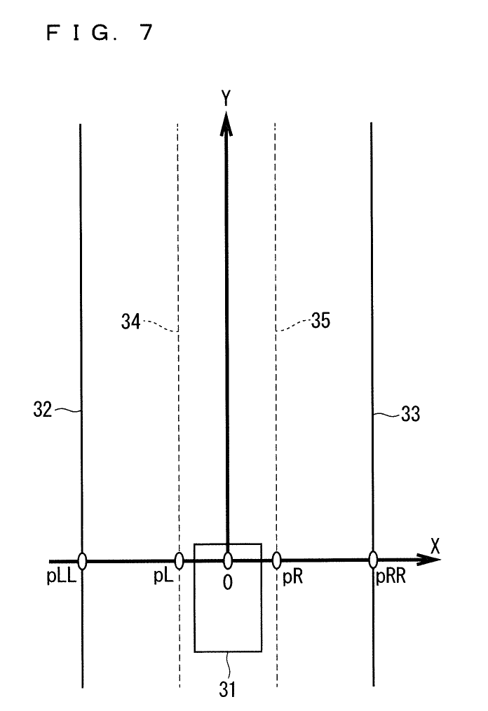

The white line information acquisition unit 13 acquires white line information on all the white lines within a range detectable from the vehicle. Specifically, for example, as shown in FIG. 7 to be described later, the white line information acquisition unit 13 acquires white line information on a left white line (hereinafter referred to as “left white line”) and right white line (hereinafter referred to as “right white line”) of the traveling lane facing forward in the traveling direction of the vehicle, and in addition, on left white lines and right white lines of lanes (hereinafter referred to as “adjacent lanes”) adjacent to the traveling lane.

In this embodiment, the white line information acquisition unit 13 acquires information on roads, obstacles and road signs in the above-mentioned regions in addition to the white line information in such a manner that the front camera and the rear camera capture the above-mentioned regions. The white line information acquisition unit 13 may be configured to acquire the white line information from the hardware, which is provided outside the traveling lane determining device 1, via the communication network such as the Internet. The white line information acquisition unit 13 gives the acquired white line information to the traveling lane estimator 14 and the traveling lane monitor 15.

The traveling lane estimator 14 estimates the traveling lane from the map information read out from the map database 11, the current position information given from the current position acquisition unit 12, and the white line information given from the white line information acquisition unit 13.

Specifically, the traveling lane estimator 14 acquires the identifier of the traveling road from the current position information given from the current position acquisition unit 12. From the map information read from the map database 11, the traveling lane estimator 14 acquires number-of-lanes information that indicates the number of lanes of the road on which the vehicle is traveling and line type information that indicates line types thereof.

The traveling lane estimator 14 acquires information, which indicates the line types of the white lines and the positions of the white line from the white line information given from the white line information acquisition unit 13. The traveling lane estimator 14 calculates a width (hereinafter referred to “lane width” in some cases) of the traveling lane and the adjacent lanes from the acquired information on the positions of the white lines.

The traveling lane estimator 14 stochastically estimates the traveling lane, on which the vehicle is currently traveling, from a traveling lane probability of each of the lanes, which is obtained based on the line type of the white line, a traveling lane probability of each of the lanes, which is obtained based on whether or not such an adjacent lane is present, and a traveling lane probability of each of the lanes, which is obtained based on a lane on which the vehicle traveled when the traveling lane was estimated previously. The traveling lane estimator 14 estimates that a lane, in which a traveling lane probability is largest, as the traveling lane from the traveling lane probability of each of the lanes. Here, “traveling lane probability” refers to a probability that each of the lanes is the traveling lane on which the vehicle is traveling at present.

In this embodiment, the traveling lane estimator 14 estimates the traveling lane by using the Bayesian estimation. An estimation method for the traveling lane by the traveling lane estimator 14 is not limited to this, and in another embodiment of the present invention, the traveling lane may be estimated by using another method such as maximum likelihood estimation. The traveling lane estimator 14 gives estimated lane information, which indicates the estimated traveling lane, as an estimation result to the traveling lane monitor 15.

The traveling lane monitor 15 stores the white line information, which is given from the white line information acquisition unit 13, in the white line information storage 16. The traveling lane monitor 15 monitors the traveling lane of the vehicle by monitoring a lane change of the vehicle. Upon determining that the lane change has been made, the traveling lane monitor 15 updates the number of the traveling lane, which is stored in the white line information storage 16.

Specifically, the traveling lane monitor 15 continuously monitors the white line information given from the white line information acquisition unit 13, and determines whether or not the lane change has been made based on the white line information given from the white line information acquisition unit 13, and on the white line information stored in the white line information storage 16.

More specifically, the traveling lane monitor 15 determines whether or not a detection position of the left white line and a detection position of the right white line have changed, thereby detecting whether or not the vehicle has cross the lane. The traveling lane monitor 15 determines whether or not the lane change has been made based on a detection result as to whether or not the vehicle has crossed the lane. The traveling lane monitor 15 gives a determination result as to whether or not the lane change has been made and the updated number of the traveling lane to the traveling lane decision unit 17.

The white line information storage 16 stores the white line information acquired by the white line information acquisition unit 13. The white line information storage 16 stores white line information acquired in the past. That is, the white line information storage 16 is realized by a storage device such as a semiconductor memory. The white line information storage 16 stores history information as white line information acquired by the white line information acquisition unit 13 within a predetermined time (hereinafter may be referred to as “prescribed time” in some cases).

The white line information storage 16 stores the white line information, which includes the information indicating the shapes of the white lines, the line types of the white lines and the quality of the white lines, and information indicating a time when the white line information was acquired. In addition to these, the white line information storage 16 may store information obtained by processing from the left white line and the right white line and the like.

Upon being given the estimated lane information from the traveling lane estimator 14, the traveling lane decision unit 17 decides that the lane estimated to be the traveling lane by the traveling lane estimator 14 is the traveling lane based on the given estimated lane information.

After deciding the traveling lane based on the estimated lane information given from the traveling lane estimator 14, the traveling lane decision unit 17 decides the traveling lane based on the determination result given from the traveling lane monitor 15. When the determination result given from the traveling lane monitor 15 indicates that the lane change has been made, then based on the updated number of the traveling lane, which is given from the traveling lane monitor 15, the traveling lane decision unit 17 decides that the lane with the corresponding number is the traveling lane.

When the estimation result by the traveling lane estimator 14 and the determination result by the traveling lane monitor 15 are different from each other, the traveling lane decision unit 17 preferentially uses the estimation result of the traveling lane estimator 14 when the traveling lane probability obtained by the traveling lane estimator 14 exceeds a predetermined threshold value. When the traveling lane probability obtained by the traveling lane estimator 14 is less than the predetermined threshold value, the traveling lane decision unit 17 preferentially uses the determination result of the traveling lane monitor 15.

FIG. 2 is a block diagram showing a hardware configuration of the traveling lane determining device 1 in the first embodiment of the present invention. As shown in FIG. 2, the traveling lane determining device 1 is configured by including at least a processing circuit 21, a memory 22 and an input/output interface 23.

The map database 11, the current position acquisition unit 12, the white line information acquisition unit 13 and the white line information storage 16, which are shown in FIG. 1 mentioned above, are connected to the input/output interface 23. In FIG. 1, such a configuration is adopted, in which the map database 11, the current position acquisition unit 12, the white line information acquisition unit 13 and the white line information storage 16 are disposed inside the traveling lane determining device 1; however, such a configuration in which these pieces of the hardware are externally attached to the traveling lane determining device 1 may be adopted.

Respective functions of the traveling lane estimator 14, the traveling lane monitor 15 and the traveling lane decision unit 17 in the traveling lane determining device 1 are realized by the processing circuit 21. That is, the traveling lane determining device 1 includes the processing circuit 21 for estimating the traveling lane by the traveling lane estimator 14, monitoring the traveling lane by the traveling lane monitor 15, and deciding the traveling lane by the traveling lane decision unit 17. The processing circuit 21 is a CPU (Central Processing Unit: also referred to as Central Processing Device, Processing Device, Operation Device, Microprocessor, Microcomputer, Processor, DSP (Digital Signal Processor)) that executes a program stored in the memory 22.

The functions of the traveling lane estimator 14, the traveling lane monitor 15, and the traveling lane decision unit 17 are realized by software, firmware, or a combination of the software and the firmware. The software and the firmware are described as programs, and are stored in the memory 22.

The processing circuit 21 reads out and executes the programs stored in the memory 22, thereby realizing the functions of the respective sections of the traveling lane estimator 14, the traveling lane monitor 15 and the traveling lane decision unit 17. That is, the traveling lane determining device 1 includes the memory 22 for storing such programs in which, at a time of being executed by the processing circuit 21, a step of estimating the traveling lane by the traveling lane estimator 14, a step of monitoring the traveling lane by the traveling lane monitor 15 and a step of deciding the traveling lane by the traveling lane decision unit 17 are executed consequently.

Moreover, these programs can also be said to be those which cause a computer to execute a procedure and method of processing performed by the traveling lane estimator 14, the traveling lane monitor 15 and the traveling lane decision unit 17.

Here, for example, to the memory 22, there apply a non-volatile or volatile semiconductor memory such as a RAM (Random Access Memory), a ROM (Read Only Memory), a flash memory, an EPROM (Erasable Programmable Read Only Memory) and an EEPROM (Electrically Erasable Programmable Read Only Memory), and in addition, a magnetic disk, a flexible disk, an optical disk, a compact disk, a mini disk, a DVD (Digital Versatile Disc) and the like.

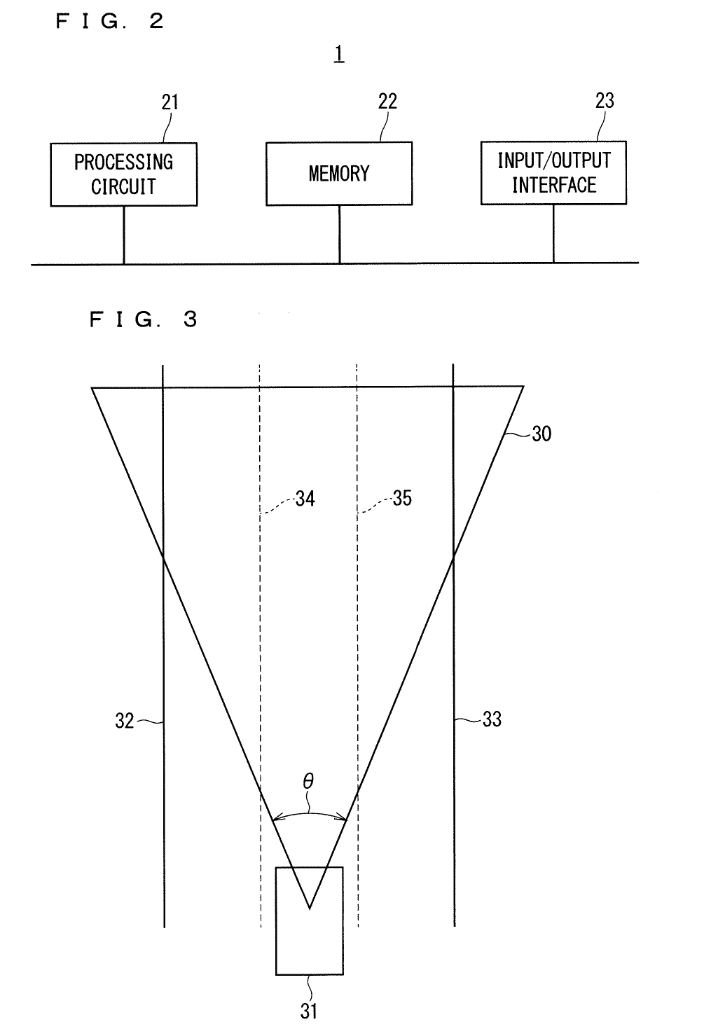

By using FIG. 3 to FIG. 9, a description will be specifically made of a determination operation for the traveling lane by the traveling lane determining device 1 of this embodiment. FIG. 3 is a view showing an example of a white line information acquirable range 30 by the white line information acquisition unit 13. In FIG. 3, the white line information acquirable range 30 on the front side in the traveling direction of the vehicle 31 is represented by a viewing angle θ of the front camera that constitutes the white line information acquisition unit 13. The front camera is configured to be capable of setting the viewing angle θ arbitrarily in response to a lane width of the road, and the like.

The white line information acquisition unit 13 can acquire white line information on white lines present within such an acquirable range 30. Specifically, as shown in FIG. 3, the white line information acquisition unit 13 can acquire white line information on a solid white line 32 on a left side facing forward in the traveling direction of the vehicle 31 and a broken white line 34 adjacent thereto on a right side, and on a solid white line 33 on a right side facing forward in the traveling direction of the vehicle 31 and a broken white line 35 adjacent thereto on a left side.

The acquirable range 30 of the white line information is not limited to the viewing angle θ of the front camera, and may be represented by other parameters. For example, the acquirable range 30 of the white line information may be represented by a viewing angle of the rear camera that constitutes the white line information acquisition unit 13, or may be represented by a detectable range of a sensor that constitutes the white line information acquisition unit 13, or may be represented as a range obtained by adding these to each other.

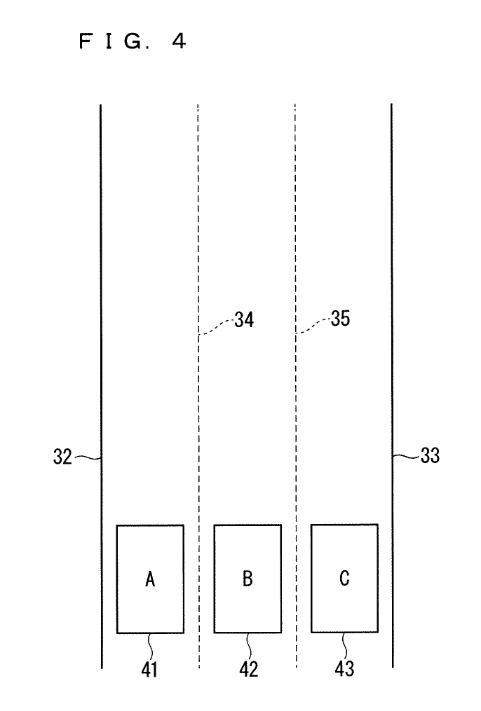

FIG. 4 is a view showing an example of a relationship between positions of vehicles and the white lines. FIG. 4 shows a case where vehicles 41 to 43 are traveling on respective lanes on a three-lane road. Here, a traveling direction of the vehicles 41 to 43 is defined to be an upward direction on a paper surface of FIG. 4, and three lanes which constitute the three-lane road shown in FIG. 4 are defined to be a first lane, a second lane and a third lane in order from the left side facing toward the traveling direction of the vehicles 41 to 43. Moreover, four white lines which divide the respective lanes are defined to be a first white line 32, a second white line 34, a third white line 35 and a fourth white line 33 in order from the left side facing toward the traveling direction of the vehicles 41 to 43. At this time, the first white line 32 and the fourth white line 33, which are roadway outside lines, are constituted of solid white lines. The second white line 34 and the third white line 35, which are lane boundary lines, are constituted of broken white lines.

In the case of the vehicle 41, which is denoted by a symbol “A”, and travels on the first lane, a left white line thereof is the solid first white line 32, and a right white line thereof is the broken second white line 34. In the case of the vehicle 42, which is denoted by a symbol “B”, and travels on the second lane, a left white line thereof is the broken second white line 34, and a right white line thereof is the broken third white line 35. In the case of the vehicle 43, which is denoted by a symbol “C”, and travels on the third lane, a left white line thereof is the broken third white line 35, and a right white line thereof is the solid fourth white line 33.

As described above, when the white lines 34 and 35 serving as the lane boundary lines are constituted of such broken lines, the line types of the left white line and the right white line change in response to the lanes on which the vehicles 41 to 43 are traveling. Hence, the traveling lane decision unit 17 can specify the traveling lane by using the relationship between the lane and the line types of the left white line and the right white line.

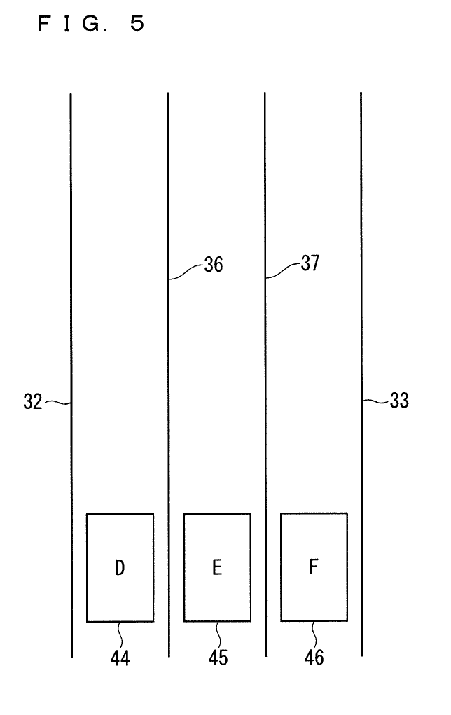

FIG. 5 is a view showing another example of the relationship between the positions of the vehicles and the white lines. FIG. 5 shows a case where the white lines 36 and 37 serving as lane boundary lines are constituted of solid lines. Also in FIG. 5, it is assumed that the road is a three-lane road, and that vehicles 44 to 46 are traveling on respective lanes.

Moreover, a traveling direction of the vehicles 44 to 46 is defined to be an upward direction on a paper surface of FIG. 5, and three lanes which constitute the three-lane road shown in FIG. 5 are defined to be a first lane, a second lane and a third lane in order from the left side facing toward the traveling direction of the vehicles 44 to 46. Moreover, four white lines which divide the respective lanes are defined to be the first white line 32, a second white line 36, a third white line 37 and the fourth white line 33 in order from the left side facing toward the traveling direction of the vehicles 44 to 46.

In the example shown in FIG. 5, the first white line 32 and the fourth white line 33, which are roadway outside lines, are constituted of solid white lines in a similar way to the case shown in FIG. 4 mentioned above. In the example shown in FIG. 5, the second white line 36 and the third white line 37, which are lane boundary lines, are constituted of broken white lines.

In the example shown in FIG. 5, in the case of the vehicle 44, which is denoted by a symbol “D”, and travels on the first lane, a left white line thereof and a right white line thereof are the white lines 32 and 36, both of which are solid lines. Also in the case of the vehicle 45, which is denoted by a symbol “E”, and travels on the second lane, in a similar way, a left white line thereof and a right white line thereof are the white lines 36 and 37, both of which are solid lines. Also in the case of the vehicle 45, which is denoted by a symbol “F”, and travels on the third lane, in a similar way, a left white line thereof and a right white line thereof are the white lines 37 and 33, both of which are solid lines.

As described above, when the white lines 36 and 37 serving as the lane boundary lines are formed by such solid lines, the line types of the left white line and the right white line are the same for all the lanes. Hence, the traveling lane decision unit 17 cannot specify the traveling lane even if using the relationship between the lane and the line types of the left white line and the right white line. In this case, the traveling lane can be specified by using another method, which will be described later, in combination.

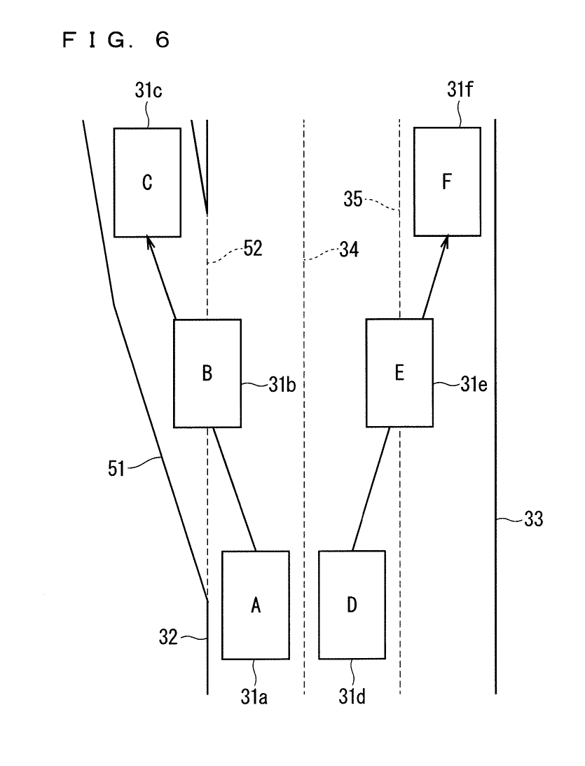

FIG. 6 is a view showing an example of a relationship between the positions of the vehicles and the white lines when lane crossing occurs. FIG. 6 shows an example of crossing of the vehicles, which occurs when a road similar to the three-lane road shown in FIG. 4 branches from the middle.

There is considered a case where a vehicle 31a, which is denoted by the symbol “A” and travels on the first lane, changes the lane from the first lane to a lane branched to the left side in the traveling direction. At a position of the vehicle 31a denoted by the symbol “A”, a left white line thereof is the solid first white line 32, and a right white line thereof is the broken second white line 34. At a position of a vehicle 31b denoted by the symbol “B”, which is a position in the middle of the lane change, a left white line thereof is a solid white line 51 that divides a lane branched from the first lane. Moreover, at the position of the vehicle 31b denoted by the symbol “B”, there occurs a state in which the vehicle 31b crosses a broken white line 52 that extends from the first white line 32 and divides the first lane and a lane branched from the first lane, and then the vehicle 31b is located on the white line 52 concerned.

At a position of a vehicle 31c denoted by the symbol “C”, which is a position at a stage where the vehicle further proceeds and the lane change is completed, both of a left white line thereof and a right white line thereof are the solid white lines 51 which divide the lane branched from the first lane.

As described above, when the lane is changed from the first lane to the lane branched to the left side in the traveling direction, the crossing of the left white line occurs, and the detection positions of the left white line and the right white line change. Hence, the traveling lane monitor 15 can determine whether or not the lane change has been made by monitoring changes of the left white line and the right white line.

Moreover, there is considered a case where a vehicle 31d, which is denoted by the symbol “D” and travels on the second lane, changes the lane to the third lane as a right lane thereof. At a position of the vehicle 31d denoted by the symbol “D”, a left white line thereof and right white line thereof are the white lines 34 and 35, both of which are broken lines. At a position of a vehicle 31e denoted by the symbol “E”, which is a position in the middle of the lane change, a right white line thereof is the solid white line 33 that divides the third lane as a right lane thereof. Moreover, at the position of the vehicle 31e denoted by the symbol “E”, there occurs a state in which the vehicle 31e crosses the broken white line 35 that divides the second lane and the third lane, and then the vehicle 31e is located on the white line 35 concerned.

At a position of a vehicle 31f denoted by the symbol “F”, which is a position at a stage where the vehicle further proceeds and the lane change is completed, a left white line thereof is the broken white line 35 that divides the third lane, and a right white line thereof is the solid white line 33 that divides the third lane.

As described above, when the lane is changed from the second lane to the third lane as the right lane, the crossing of the right white line occurs, and the line types of the left white line and the right white line change. Hence, the traveling lane monitor 15 can determine whether or not the lane change has been made by monitoring changes of the left white line and the right white line.

FIG. 7 is a view showing an example of such detection positions of the white lines. The white line information acquired by the white line information acquisition unit 13 is represented in such a manner that a center position of the vehicle 31 is taken as an origin, that forward in the traveling direction is taken as positive in a Y-axis direction, and that rightward facing toward the traveling direction is taken as positive in an X-axis direction.

As shown in FIG. 7, when the vehicle 31 is traveling on the second lane at the center of the road constituted of three lanes, then the second white line 34, which is the left white line on the left side facing toward the traveling direction between the two white lines 34 and 35 that divide the second lane as the traveling lane, is detected at a position pL. The third white line 35, which is the right white line on the right side facing toward the traveling direction, is detected at a position pR.

The first white line 32 that divides the first lane adjacent to the left side of the second lane is detected at a position pLL further on the left side of the detection position pL of the second white line 34. The fourth lane 33 that divides the third lane adjacent to the right side of the second lane is detected at a position pRR further on the right side of the detection position pR of the third white line 35.

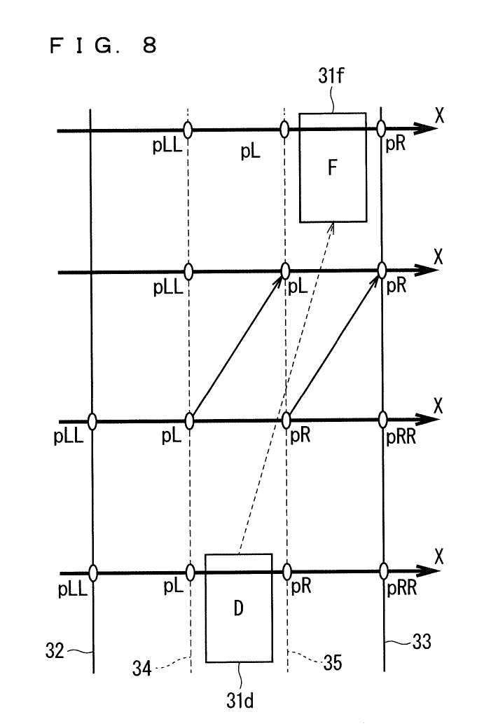

FIG. 8 is a view showing an example of the detection positions of the white lines, which are changed by the lane crossing. In a similar way to the vehicle 31 shown in FIG. 7, there is considered a case where the vehicle 31d denoted by the symbol “D” performs the lane change to the third lane as the right lane from the state of traveling on the second lane, and moves to the position of the vehicle 31f denoted by the symbol “F”. In this case, there change the detection position pL of the left white line of the vehicle 31, the detection position pR of the right white line thereof, the detection position pLL of the left white line of the left adjacent lane, and the detection position pRR of the right white line of the right adjacent lane.

Hence, the traveling lane monitor 15 monitors the detection positions pL and pR of the left white line and the right white line, which divide the traveling lane, and temporal changes of the detection positions pLL and pRR of the left white line and the right white line which divide the adjacent lanes, and can thereby detect the change of the lane.

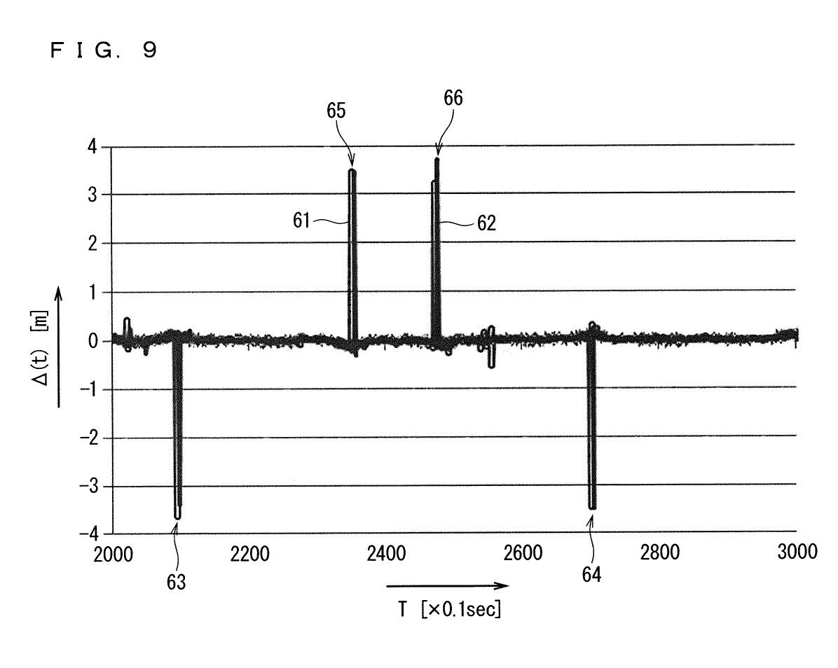

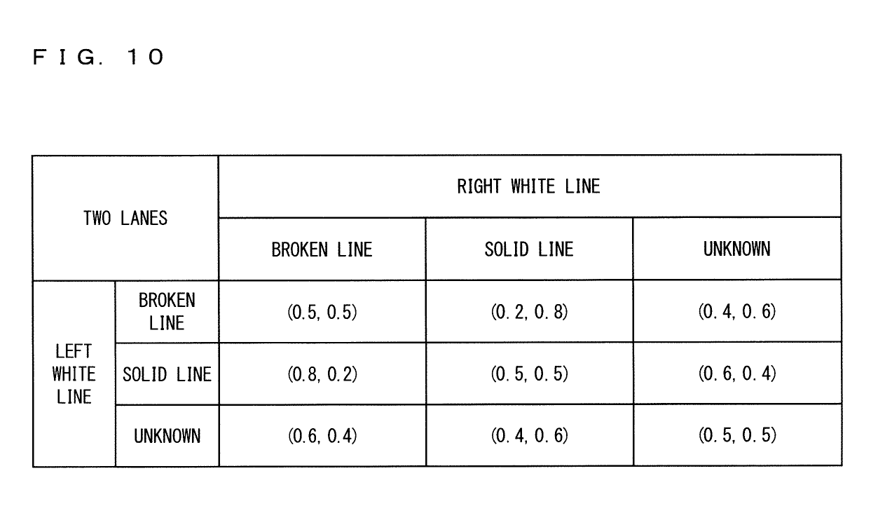

FIG. 9 is a graph showing the temporal changes of the detection positions of the white lines. In FIG. 9, an axis of abscissas indicates a time T [×0.1 sec], and an axis of ordinates indicates a position variation Δ(t) [m] that is a difference obtained by subtracting a detection position of the white line at time t−1 from a detection position of the white line at time t. In FIG. 9, such a position variation Δ(t) of the left white line on the left side facing toward the traveling direction of the vehicle is represented by a line denoted by reference numeral “61”, and such a position variation Δ(t) of the right white line on the right side facing toward the traveling direction of the vehicle is represented by a line denoted by reference numeral “62”.

As shown in FIG. 9, at the positions denoted by reference numerals “63” and “64”, both of the position variation 61 of the left white line and the position variation 62 of the right white line take negative values. As shown in FIG. 7, with regard to each of the position pL of the left white line and the position pR of the right white line, the right side facing toward the traveling direction Y is taken as the positive direction of the X axis, and accordingly, the fact that the position variation Δ(t) is negative means that the position pL of the left white line and the position pR of the right white line have changed to the left direction. Hence, it is seen that the lane change to the left lane is made at the positions denoted by reference numerals “63” and “64”.

Moreover, at the positions denoted by reference numerals “65” and “66”, both of the position variation 61 of the left white line and the position variation 62 of the right white line take positive values. As shown in FIG. 7, with regard to the position pL of the left white line and the position pR of the right white line, the right side facing toward the traveling direction Y is taken as the positive direction of the X axis, and accordingly, the fact that the position variation Δ(t) is positive means that the position pL of the left white line and the position pR of the right white line have changed to the right direction. Hence, it is seen that the lane change to the right lane is made at the positions denoted by reference numerals “65” and “66”.

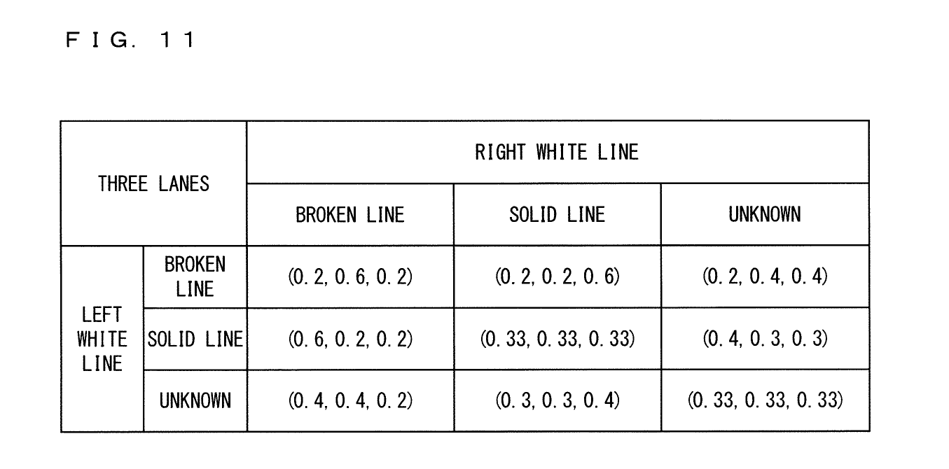

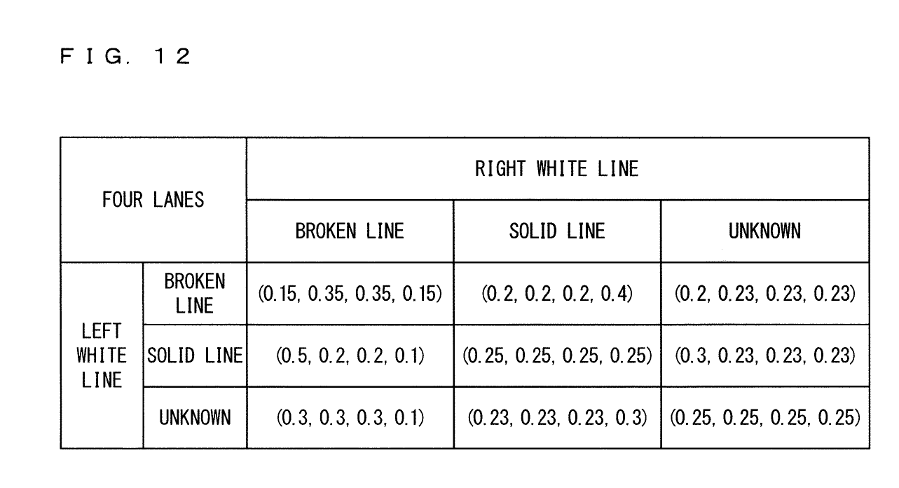

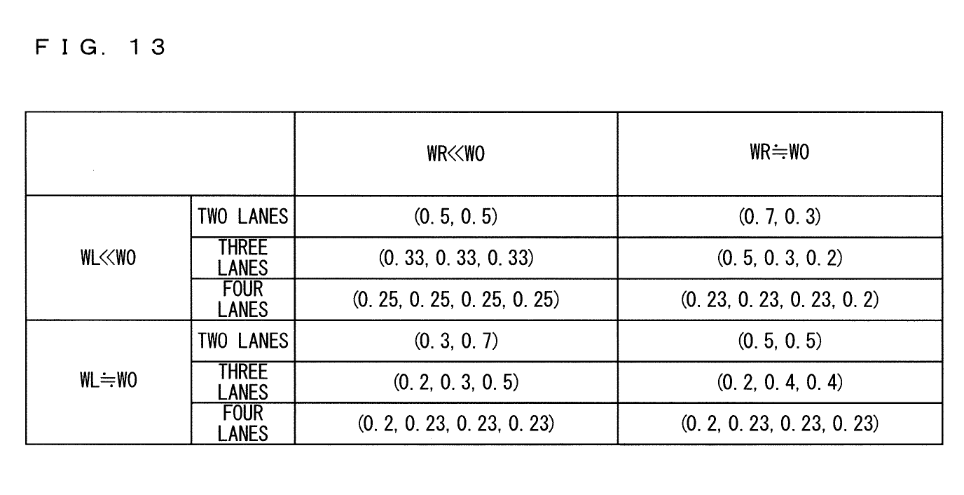

FIG. 10 to FIG. 12 are tables showing an example of traveling lane probability lists for use in the traveling lane estimator 14. FIG. 10 is a table showing an example of a traveling lane probability list on a road with two lanes. FIG. 11 is a table showing an example of a traveling lane probability list on a road with three lanes. FIG. 12 is a table showing an example of a traveling lane probability list on a road with four lanes. The traveling lane probability lists are tables for estimating the traveling lane, in which traveling lane probabilities of the respective lanes, which correspond to the line types of the left white lines and the line types of the right white lines, are obtained for each number of lanes. In FIG. 10 to FIG. 12, for each of the line types of the left white lines and the right white lines, the traveling lane probabilities of the respective lanes which constitute the road are shown.

In FIG. 10, two lanes are taken as the first lane and the second lane in order from the left side facing toward the traveling direction of the vehicle. In each of columns in FIG. 10, the traveling lane probability Pω1 of the first lane and the traveling lane probability Pω2 of the second lane are expressed as “(Pω1, Pω2)”.

In FIG. 11, three lanes are taken as the first lane, the second lane and the third lane in order from the left side facing toward the traveling direction of the vehicle. In each of columns in FIG. 11, the traveling lane probability Pω1 of the first lane, the traveling lane probability Pω2 of the second lane and the traveling lane probability Pω3 of the third lane are expressed as “(Pω1, Pω2, Pω3)”.

In FIG. 12, four lanes are taken as the first lane, the second lane, the third lane and a fourth lane in order from the left side facing toward the traveling direction of the vehicle. In each of columns in FIG. 12, the traveling lane probability Pω1 of the first lane, the traveling lane probability Pω2 of the second lane, the traveling lane probability Pω3 of the third lane and a traveling lane probability Pω4 of the fourth lane are expressed as “(Pω1, Pω2, Pω3, Pω4)”.

The traveling lane estimator 14 can estimate the traveling lane, for example by using the traveling lane probability lists shown in FIG. 10 to FIG. 12. The traveling lane probability list is stored in the map database 11. In this embodiment, the traveling lane probabilities are defined in advance, but are not limited to this. For example, the traveling lane estimator 14 may update, by learning, each of the traveling lane probabilities stored in the map database 11, or an external device may update, via communication, the traveling lane probabilities stored in the map database 11.

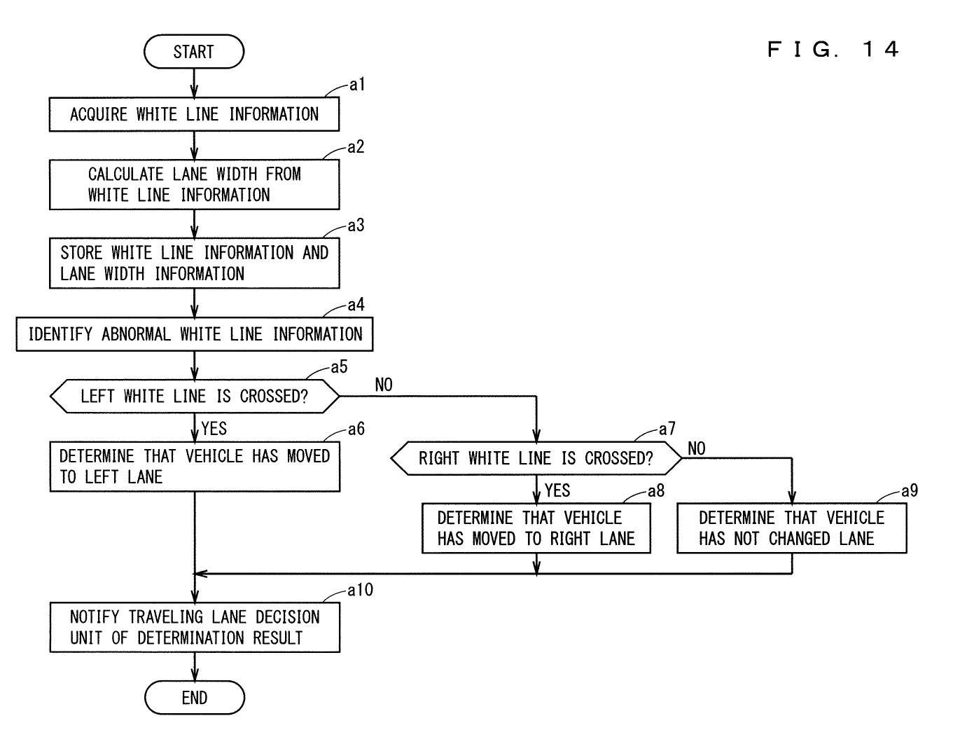

FIG. 13 is a table showing another example of the traveling lane probability list for use in the traveling lane estimator 14. FIG. 13 shows an example of the traveling lane probabilities of the respective lanes, which are obtained based on whether or not there is an adjacent lane. FIG. 13 shows the traveling lane probabilities in the cases of two lanes, three lanes and four lanes. In FIG. 13, a lane width of the left lane is indicated by a symbol “WL”, a lane width of the right lane is indicated by a symbol “WR”, and a prescribed width as a predetermined lane width is indicated by a symbol “W0”.

For example, there is considered a case where the lane width WL of the left lane is extremely smaller than the prescribed width W0 (WL<<W0) and the lane width WR of the right lane is substantially equal to the prescribed width W0 (WR≈W0). In this case, when the number of lanes is 3, that is, when the road has three lanes, it is conceived that there is no lane on the left side of the traveling lane and there is a lane on the right side of the traveling lane. Hence, the traveling lane probabilities of the respective lanes are set to a probability Pb=(0.5, 0.3, 0.2), for example, as shown in FIG. 13. That is, the traveling lane probability Pb1 of the first lane is set to 0.5, the traveling lane probability Pb2 of the second lane is set to 0.3, and the traveling lane probability Pb3 of the third lane is set to 0.2.

When the lane width WL of the left lane is extremely smaller than the prescribed width W0 (WL<<W0) and the lane width WR of the right lane is extremely smaller than the prescribed width W0 (WR<<W0), when the lane width WL of the left lane is substantially equal to the prescribed width W0 (WL≈W0) and the lane width WR of the right lane is extremely smaller than the prescribed width W0 (WR<<W0), and when the lane width WL of the left lane is substantially equal to the prescribed width W0 (WL≈W0) and the lane width WR of the right lane is substantially equal to the prescribed width W0 (WR≈W0), then the traveling lane probabilities of the respective lanes are set as shown in FIG. 13, respectively.

The traveling lane estimator 14 can estimate the traveling lane, for example by using the traveling lane probability list shown in FIG. 13. The traveling lane probability list is stored in the map database 11. The traveling lane probabilities are those defined in advance in this embodiment, but may be updated by learning, or may be updated via communication.

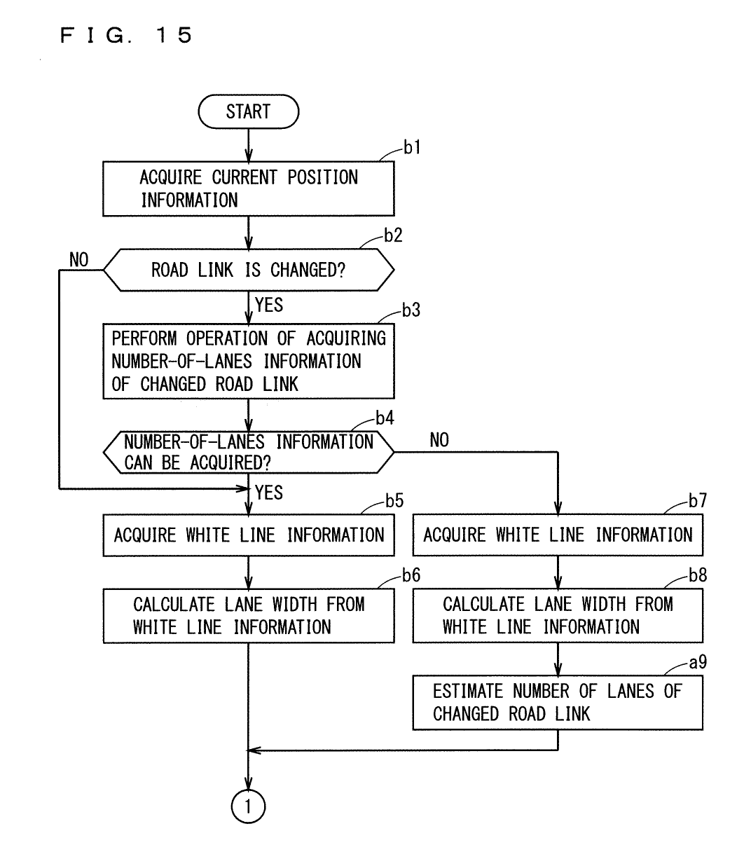

FIG. 14 is a flowchart showing a processing procedure with regard to lane change determination processing in the traveling lane determining device 1 of the first embodiment of the present invention. Respective processes of the flowchart shown in FIG. 14 are executed by the white line information acquisition unit 13 and the traveling lane monitor 15. The flowchart shown in FIG. 14 is started when a power supply of the traveling lane determining device 1 is turned on, or is started every predetermined cycle, and the processing proceeds to Step a1.

In Step a1, the white line information acquisition unit 13 acquires the white line information. When the process of Step a1 is ended, the processing proceeds to Step a2.

In Step a2, the traveling lane monitor 15 calculates the lane width from the white line information acquired in Step a1. When the process of Step a2 is ended, the processing proceeds to Step a3.

In Step a3, the traveling lane monitor 15 stores the white line information, which is acquired in Step a1, and the lane width information, which indicates the lane width and is calculated in Step a2, in the white line information storage 16. When the process of Step a3 is ended, the processing proceeds to Step a4.

In Step a4, the traveling lane monitor 15 identifies abnormal white line information. Details of the process of Step a4 will be described later. When the process of Step a4 is ended, the processing proceeds to Step a5.

In Step a5, the traveling lane monitor 15 determines whether or not the vehicle has crossed the left white line. When it is determined that the vehicle has crossed the left white line, the processing proceeds to Step a6, and when it is determined that the vehicle has not crossed the left white line, the processing proceeds to Step a7.

In Step a6, the traveling lane monitor 15 determines that the vehicle has moved to the left lane. When the process of Step a6 is ended, the processing proceeds to Step a10.

In Step a7, the traveling lane monitor 15 determines whether or not the vehicle has crossed the right white line. When it is determined that the vehicle has crossed the right white line, the processing proceeds to Step a8, and when it is determined that the vehicle has not crossed the right white line, the processing proceeds to Step a9.

In Step a8, the traveling lane monitor 15 determines that the vehicle has moved to the right lane. When the process of Step a8 is ended, the processing proceeds to Step a10.

In Step a9, the traveling lane monitor 15 determines that the vehicle has not changed the lane. When the process of Step a9 is ended, the processing proceeds to Step a10.

In Step a10, the traveling lane monitor 15 notifies the traveling lane decision unit 17 of a determination result in Step a6, Step a8 or Step a9. When the process of Step a10 is ended, all the processing procedure of FIG. 14 is ended.

Specifically, the determinations in Step a6 to Step a9 as to whether or not the vehicle has crossed the white lines and whether or not the vehicle has changed the lane are made as follows.

In Step a6, from time series data of the left white line, it is determined whether or not the vehicle has crossed the left white line. The position pL of the left white line is detected to be shifted by approximately a half of the lane width W0 during normal traveling. The center of the vehicle is a zero point, and accordingly, when the central portion of the vehicle crosses the white line, the position of the detected white line changes.

When the vehicle moves to the right lane, the white line that was seen on the right side is seen on the left side, and the white line that was seen on the right side of the right adjacent lane is seen on the right side of the vehicle. When the vehicle moves to the left lane, the white line that was seen on the right side is seen on the right adjacent lane, and the white line that was seen on the left side is seen on the right side. In this way, it can be determined whether or not the lane is changed, and the direction of the lane change can be determined.

The position variation Δ(t), which is a difference between the detection position X=pL(t−1) of the left white line at time t−1 and the detection position X=pL(t) of the left white line at time t, can be expressed as in the following Expression (1).

[Expression 1]

Δ(t)=pL(t)−pL(t−1) (1)

If the position variation Δ(t) is within a range of the prescribed width W0±an allowable error α, the prescribed width W0 being a predetermined lane width, then it is determined that the lane is changed, and if the position variation Δ(t) is out of the range, then the position variation Δ(t) is determined to be within a range of a sensing error, and is not treated as the lane change. Moreover, for the a of the prescribed width W0±α, 2α, 3α and the like may be set, and the position variation Δ(t) may be calculated as crossing probabilities P_left as in the following Expressions (2) to (5).

[Expression 2]

P_left=1.0 (when W−σ<|Δ(t)|<W+σ) (2)

[Expression 3]

P_left=0.8 (when W−1.5σ<|Δ(t)|<W+1.5σ) (3)

[Expression 4]

P_left=0.6 (when W−2.0σ<|Δ(t)|<W+2.0σ) (4)

[Expression 5]

P_left=0.4 (when W−2.5σ<|Δ(t)|<W+2.5σ) (4)

These do not necessarily occur simultaneously on the left and right white lines, and accordingly, are determined within a predetermined time. Weights are assigned to the calculated probabilities based on quality information of the white lines, whereby the traveling lane is estimated. When it can be determined that both of the left and light lines are crossed in Step a5 and Step a6, then it is determined that the lane is changed. When the position variation is calculated by the probabilities, it is determined that the lane is changed when a product of P_left and P_right exceeds a predetermined threshold value.

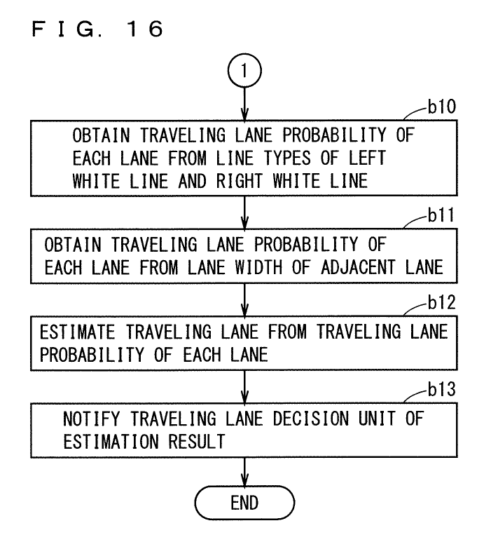

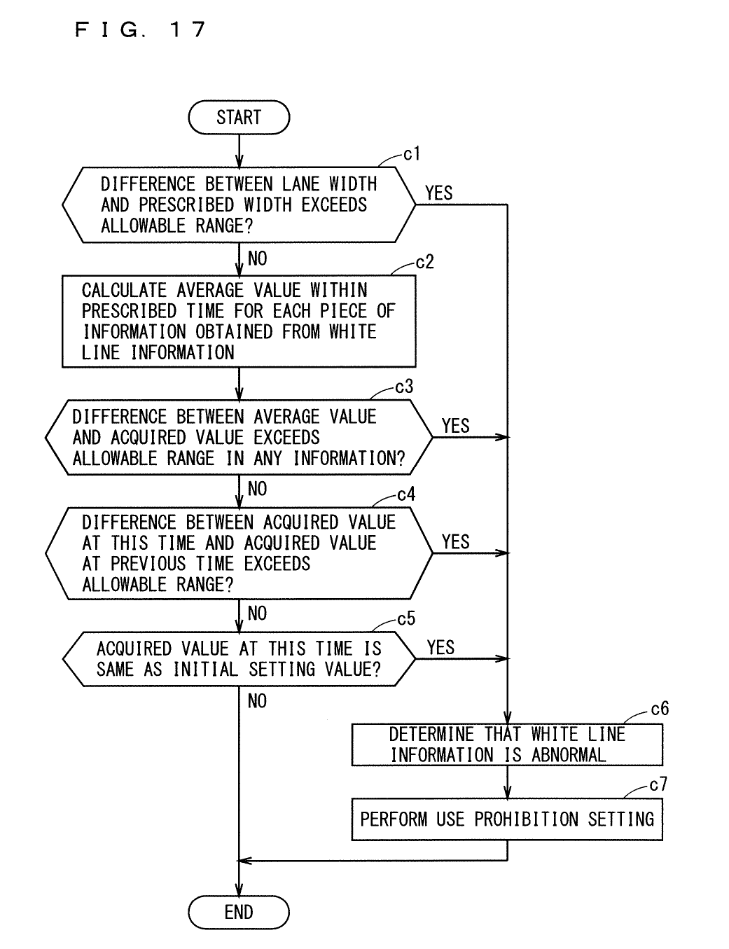

FIG. 15 and FIG. 16 are a flowchart showing a processing procedure with regard to traveling lane estimation processing in the traveling lane determining device 1 of the first embodiment of the present invention. Respective processes of the flowchart shown in FIG. 15 and FIG. 16 are executed by the current position acquisition unit 12, the white line information acquisition unit 13 and the traveling lane estimator 14. The flowchart shown in FIG. 15 and FIG. 16 is started when a power supply of the traveling lane determining device 1 is turned on, or is started every predetermined cycle, and the processing proceeds to Step b1.

In Step b1, the current position acquisition unit 12 acquires the current position information. When the process of Step b1 is ended, the processing proceeds to Step b2.

In Step b2, the traveling lane estimator 14 determines whether or not the road link has changed. When it is determined that the road link has changed, the processing proceeds to Step b3, and when it is determined that the road link has not changed, the processing proceeds to Step b5.

In Step b3, the traveling lane estimator 14 performs an operation of acquiring the number-of-lanes information of the changed road link. When the process of Step b3 is ended, the processing proceeds to Step b4.

In Step b4, the traveling lane estimator 14 determines whether or not the number-of-lanes information has been able to be acquired. When it is determined that the number-of-lanes information has been able to be acquired, the processing proceeds to Step b5, and when it is determined that the number-of-lanes information has not been able to be acquired, the processing proceeds to Step b7.

In Step b5, the white line information acquisition unit 13 acquires the white line information. When the process of Step b5 is ended, the processing proceeds to Step b6.

In Step b6, the traveling lane estimator 14 calculates the lane width from the white line information acquired in Step b5. When the process of Step b6 is ended, the processing proceeds to Step b10 of FIG. 16.

In Step b7, the white line information acquisition unit 13 acquires the white line information. When the process of Step b7 is ended, the processing proceeds to Step b8.

In Step b8, the traveling lane estimator 14 calculates the lane width from the white line information acquired in Step b7. When the process of Step b8 is ended, the processing proceeds to Step b9.

In Step b9, the traveling lane estimator 14 estimates the number of lanes of the changed road link. When the process of Step b9 is ended, the processing proceeds to Step b10 of FIG. 16.

In Step b10 of FIG. 16, the traveling lane estimator 14 obtains the traveling lane probability of each lane from the line types of the left white line and the right white line.

When the process of Step b10 is ended, the processing proceeds to Step b11.

In Step b11, the traveling lane estimator 14 obtains the traveling lane probability of each lane from the lane width of the adjacent lane. When the process of Step b11 is ended, the processing proceeds to Step b12.

In Step b12, the traveling lane estimator 14 estimates the traveling lane from the traveling lane probability of each lane. When the process of Step b12 is ended, the processing proceeds to Step b13.

In Step b13, the traveling lane estimator 14 notifies the traveling lane decision unit 17 of an estimation result. When the process of Step b13 is ended, all the processing procedure of FIG. 15 and FIG. 16 is ended.

Specifically, the estimation of the traveling lane in Step b12 is performed as follows. By using the traveling lane probabilities calculated in Step b10 and Step b11, probability weighting is applied to the traveling lane on which the vehicle has traveled until immediately before, and the estimation of the traveling lane is performed comprehensively. In this embodiment, the traveling lane is stochastically determined by the Bayesian estimation.

Likelihood P(X|Hk) is calculated as in the following Expression (6) by synthesizing, with one another, a line type matching probability P1(X) of the left white line and the right white line, a number-of-lanes matching probability P2(X) corresponding to whether or not the left and right lanes are present, and a traveling lane probability P3(X) predicted from the previously decided traveling lane and lane change.

[Expression 6]

P(X|Hk)=α·P1(X)+(1−α−β)·P2(X)+β·P3(X) (6)

In Expression (6), a is a parameter dynamically changed based on a reliability of camera-sensed data, whether or not an abnormal value is present, and whether or not a high-accuracy map is present, and β is a weighting parameter to a history.

For a prior probability P(HK), a default value thereof is set to a uniform distribution between the respective lanes, and values thereof at a second time and after are set to P(Hk|X) calculated from posterior probabilities. The default value is set to the uniform distribution with respect to the number of lanes, and accordingly, the prior probability in the case of the road with three lanes is as shown in the following Expression (7).

[Expression 7]

P(H1)=P(H2)=P(H3)=0.333 (7)

With regard to the posterior probability P(Hk|X) of the traveling lane (event Hk, k=1, 2, 3, . . . , n (n is the number of lanes)) in the case where a traveling lane predicted from a current camera occurs (event X), the posterior probability P(Hk|X) concerned is calculated from the likelihood P(X|Hk) of the event X and the prior probability P(Hk) by using the Bayesian estimation formula shown in the following Expression (8).

$$\begin{matrix}[ Expression 8 ] & \\ P ( Hk \vert X ) = \frac{P ( X \vert Hk ) P ( Hk )}{P ( X )} = \frac{P ( X \vert Hk ) P ( Hk )}{{\sum }_{i} P ( X \vert Hki ) P ( Hki )} & ( 8 )\end{matrix}$$

It is determined that k having a maximum posterior probability P(Hk|X) is such a traveling lane Ln (t), and at a point of time when the probability exceeds a threshold value, it is determined that the vehicle travels on the lane, and the processing of the traveling lane monitor 15 is started.

In a case of having determined that the lane change has occurred, the traveling lane monitor 15 resets the posterior probability P(Hk|X) and the likelihood P(X|Hk), that is, sets a variable i in Expression (8) to 0(i=0), thereby newly calculating a posterior probability P(Hk|X) of the traveling lane, which is based on a current observed value.

Moreover, the traveling lane monitor 15 resets the posterior probability P(Hk|X) and the likelihood P(X|Hk) also in the following cases (1) to (7).

(1) Lane change

(2) Right and left turning

(3) Time of branching/joining and entering junction

(4) Time when number of lanes increases/decreases

(5) When number of lanes becomes known from unknown

(6) When number of lanes becomes unknown from known

(7) Time when switching is made between road and outside of road

When the number of lanes on such a traveling road has changed, then allocation of the lane numbers is changed, and accordingly, the lane number of the lane on which the vehicle is traveling is also updated. For example, when the number of lanes has increased by one lane on the left side, then the traveling lane number increases by one, and when the number of lanes has increased by one lane on the right side, the traveling lane left as it is.

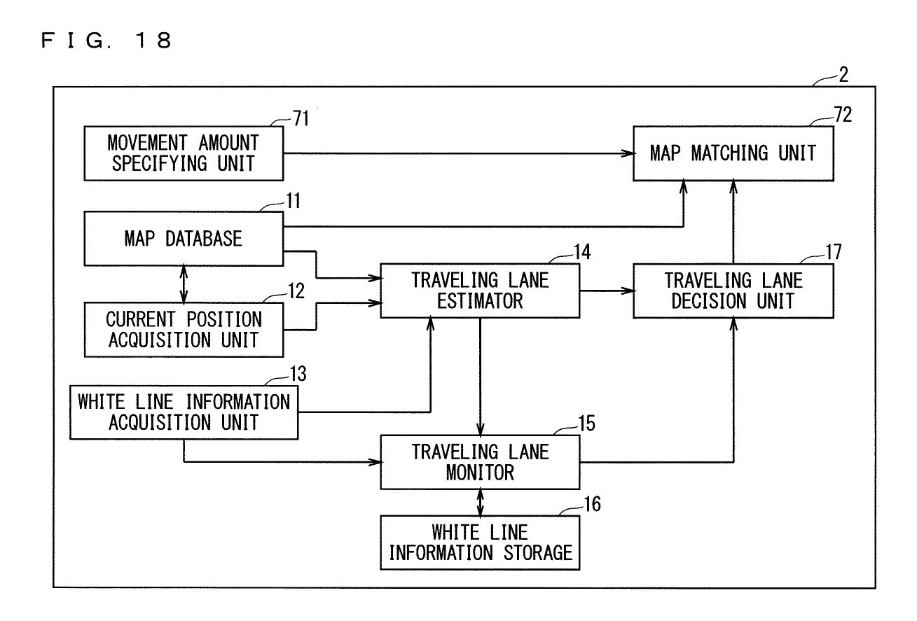

FIG. 17 is a flowchart showing a processing procedure with regard to identification processing for the abnormal white line information in the traveling lane determining device 1 of the first embodiment of the present invention. Respective processes of the flowchart shown in FIG. 17 are executed by the traveling lane monitor 15. The flowchart shown in FIG. 17 is started when the power supply of the traveling lane determining device 1 is turned on, or is started every predetermined cycle, and the processing proceeds to Step c1.

In Step c1, the traveling lane monitor 15 determines whether or not a difference between the lane width and the prescribed width exceeds an allowable range. When it is determined that the difference between the lane width and the prescribed width exceeds the allowable range, then the processing proceeds to Step c6, and when it is determined that the difference between the lane width and the prescribed width does not exceed the allowable range, then the processing proceeds to Step c2.

In Step c2, the traveling lane monitor 15 calculates an average value within a prescribed time for each piece of information obtained from the white line information. When the process of Step c2 is ended, the processing proceeds to Step c3.

In Step c3, the traveling lane monitor 15 determines whether or not the difference between the average value and an acquired value exceeds the allowable range in any piece of information. When it is determined that the difference between the average value and the acquired value exceeds the allowable range in any piece of the information, then the processing proceeds to Step c6, and when it is determined that the difference between the average value and the acquired value does not exceed the allowable range in any piece of the information, then the processing proceeds to Step c4.

In Step c4, the traveling lane monitor 15 determines whether or not a difference between the current acquired value and the previous acquired value exceeds an allowable range. When it is determined that the difference between the current acquired value and the previous acquired value exceeds the allowable range, then the processing proceeds to Step c6, and when it is determined that the difference between the current acquired value and the previous acquired value does not exceed the allowable range, then the processing proceeds to Step c5.

In Step c5, the traveling lane monitor 15 determines whether or not the current acquired value is the same as an initial setting value. When it is determined that the current acquired value is the same as the initial setting value, the processing proceeds to Step c6, and when it is determined that the current acquired value is not the same as the initial setting value, all the processing procedure in FIG. 17 is ended.

In Step c6, the traveling lane monitor 15 determines that the white line information is abnormal. When the process of Step c6 is ended, the processing proceeds to Step c7.

In Step c7, the traveling lane monitor 15 makes setting to be incapable of using the white line information determined to be abnormal in Step c6. When the process of Step c7 is ended, all the processing procedure of FIG. 17 is ended.

As described above, in accordance with this embodiment, by the traveling lane estimator 14, the traveling lane is estimated based on the traveling lane probability of each of the lanes, which is obtained based on the line type of the white line, the traveling lane probability of each of the lanes, which is obtained based on whether or not the adjacent lane is present, and the traveling lane probability of each of the lanes, which is obtained based on the lane on which the vehicle traveled when the traveling lane was estimated previously. In this way, the traveling lane can be estimated with good accuracy. Moreover, when the detection accuracy for the white line is relatively low, the traveling lane can be estimated by using any traveling lane probability among the above-mentioned traveling lane probabilities, and accordingly, estimation with relatively high robustness can be carried out. Hence, the traveling lane of the vehicle can be determined stably.

Moreover, in this embodiment, when the number-of-lanes information cannot be acquired from the map information, the traveling lane estimator 14 estimates the number of lanes based on the traveling lane probability of each of the lanes, which is obtained based on whether or not the adjacent lane is present, and based on the number of times that the vehicle changes the lane, and estimates the traveling lane based on the estimated number of lanes. In this way, even if the number-of-lanes information cannot be acquired from the map information, the traveling lane can be estimated.

Moreover, in this embodiment, when the same white line information is continuously acquired by the white line information acquisition unit 13, the traveling lane estimator 14 estimates the traveling lane based on the traveling lane probability of each of the lanes, which is obtained based on whether or not the adjacent lane is present, and based on the traveling lane probability of each of the lanes, which is obtained based on the lane on which the vehicle was traveling when the traveling lane was estimated previously. That is, when the same white line information is continuously acquired by the white line information acquisition unit 13, the traveling lane estimator 14 predicts that the state is a temporary abnormal, and estimates the traveling lane without using the traveling lane probability that is based on the white line information acquired by the white line information acquisition unit 13. In this way, the traveling lane can be estimated with better accuracy.

Moreover, in this embodiment, when the traveling lane probability of a different lane exceeds the predetermined threshold value after estimating the traveling lane, the traveling lane estimator 14 updates the traveling lane to the above-mentioned different lane. In this way, the traveling lane can be estimated with better accuracy.

Moreover, in this embodiment, when it is determined that the white line has been crossed from the temporal change of the white line information acquired by the white line information acquisition unit 13, the traveling lane estimator 14 newly estimates the traveling lane. In this way, such estimation accuracy for the traveling lane can be enhanced. Moreover, the estimation accuracy for the traveling lane can be maintained.

Moreover, in this embodiment, based on the lane width of each of the lanes which is predicted from the white line information, the line type of the white line thereof, and the information on the surrounding vehicles, the traveling lane estimator 14 predicts whether or not the adjacent lane is present, and based on a result of the prediction, obtains the traveling lane probability of each of the lanes, which is obtained based on whether or not the adjacent lane is present. In this way, such estimation accuracy for the traveling lane can be enhanced.

Moreover, in this embodiment, when the number of times that the lane is changed, which is acquired from the white line information, is larger than the number of lanes, which is obtained from the map information, the traveling lane estimator 14 determines that the map information is wrong, and estimates the traveling lane. In this way, even if the map information is wrong, the traveling lane can be estimated with good accuracy.

### Second Embodiment

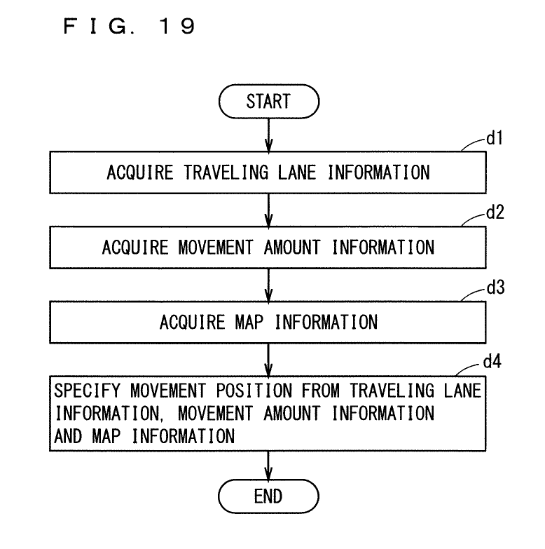

FIG. 18 is a block diagram showing a configuration of a traveling lane determining device 2 in a second embodiment of the present invention. The traveling lane determining device 2 of this embodiment includes the same constituents as those of the traveling lane determining device 1 of the first embodiment, and accordingly, the same reference numerals are assigned to the same constituents, and a common description is omitted.

In a similar way to the first embodiment, the traveling lane determining device 2 of this embodiment is configured to be mountable on a vehicle, for example, an automobile. Moreover, in this embodiment, the traveling lane determining device 2 is realized by a navigation device having a navigation function to guide a route. A traveling lane determining method as another embodiment of the present invention is executed by the traveling lane determining device 2 of this embodiment.

The traveling lane determining device 2 is configured by further including a movement amount specifying unit 71 and a map matching unit 72 in addition to the configuration of the traveling lane determining device 1 of the first embodiment. That is, the traveling lane determining device 2 is configured by including the map database 11, the current position acquisition unit 12, the white line information acquisition unit 13, the traveling lane estimator 14, the traveling lane monitor 15, the white line information storage 16, the traveling lane decision unit 17, the movement amount specifying unit 71, and the map matching unit 72.

The movement amount specifying unit 71 is configured, for example, of a gyro sensor, a vehicle speed sensor, an acceleration sensor, and a magnetic sensor. The movement amount specifying unit 71 calculates a movement amount of the vehicle based on information detected by the gyro sensor, the vehicle speed sensor, the acceleration sensor and the magnetic sensor by using a method called self-contained navigation or dead reckoning. Specifically, the movement amount specifying unit 71 calculates a distance and a direction, in which the vehicle has moved, as a movement amount of the vehicle.

The movement amount specifying unit 71 gives the map matching unit 72 movement amount information indicating the calculated movement amount of the vehicle, for example, the distance and the direction in which the vehicle has moved. The movement amount specifying unit 71 may calculate the movement amount of the vehicle, such as the distance and direction in which the vehicle has moved, from the camera, the laser radar, or the like.

The map matching unit 72 specifies the position of the vehicle on the map, which is based on the map information, based on the traveling lane information, which indicates the traveling lane and is given from the traveling lane decision unit 17, and based on the movement amount information given from the movement amount specifying unit 71. Specifically, the map matching unit 72 specifies which spot on which lane of which road on the map included in the map information read out from the map database 11 the vehicle is present.

A hardware configuration of the traveling lane determining device 2 in this embodiment is similar to the hardware configuration of the traveling lane determining device 1 shown in FIG. 2, and accordingly, illustration and a common description will be omitted. In a similar way to the traveling lane determining device 1 shown in FIG. 2, the traveling lane determining device 2 is configured by including at least a processing circuit, a memory and an input/output interface.

Respective functions of the movement amount specifying unit 71 and the map matching unit 72 in the traveling lane determining device 2 are realized by the processing circuit. That is, the traveling lane determining device 2 includes the processing circuit for specifying the movement amount of the vehicle by the movement amount specifying unit 71, and for specifying the position of the vehicle on the map, which is based on the map information, based on the traveling lane information and the movement amount information by the map matching unit 72.

The functions of the movement amount specifying unit 71 and the map matching unit 72 in the traveling lane determining device 2 are realized by software, firmware, or a combination of the software and the firmware. The software and the firmware are described as programs, and are stored in the memory.

The processing circuit reads out and executes the programs stored in the memory, thereby realizing the functions of the respective sections of the movement amount specifying unit 71 and the map matching unit 72. That is, the traveling lane determining device 2 includes the memory for storing such a program in which, at a time of being executed by the processing circuit, a step of specifying the movement amount of the vehicle by the movement amount specifying unit 71 and a step of specifying the position of the vehicle on the map, which is based on the map information, based on the traveling lane information and the movement amount information by the map matching unit 72 are executed consequently.

Moreover, this program can also be said to be that which causes a computer to execute a procedure and method of the processing performed by the movement amount specifying unit 71 and the map matching unit 72 in the traveling lane determining device 2.

FIG. 19 is a flowchart showing a processing procedure with regard to such position specifying processing in the traveling lane determining device 2 of the second embodiment of the present invention. Respective processes of the flowchart shown in FIG. 19 are executed by the map matching unit 72. The flowchart shown in FIG. 19 is started when the power supply of the traveling lane determining device 2 is turned on, or is started every predetermined cycle, and the processing proceeds to Step d1.

In Step d1, the map matching unit 72 acquires the traveling lane information from the traveling lane decision unit 17. When the process of Step d1 is ended, the processing proceeds to Step d2.

In Step d2, the map matching unit 72 acquires the movement amount information from the movement amount specifying unit 71. When the process of Step d2 is ended, the processing proceeds to Step d3.

In Step d3, the map matching unit 72 acquires the map information from the map database 11. When the process of Step d3 is ended, the processing proceeds to Step d4.

In Step d4, the map matching unit 72 specifies the movement position of the vehicle from the traveling lane information acquired in Step d1, the movement amount information acquired in Step d2, and the map information acquired in Step d3. When the process of Step d4 is ended, all the processing procedure of FIG. 19 is ended.

As described above, in accordance with this embodiment, after the traveling lane is decided by the traveling lane decision unit 17, the vehicle is mapped on the map by the map matching unit 72 while taking the movement amount of the vehicle into consideration. In this way, the current position of the vehicle can be specified with relatively high accuracy.

### Third Embodiment

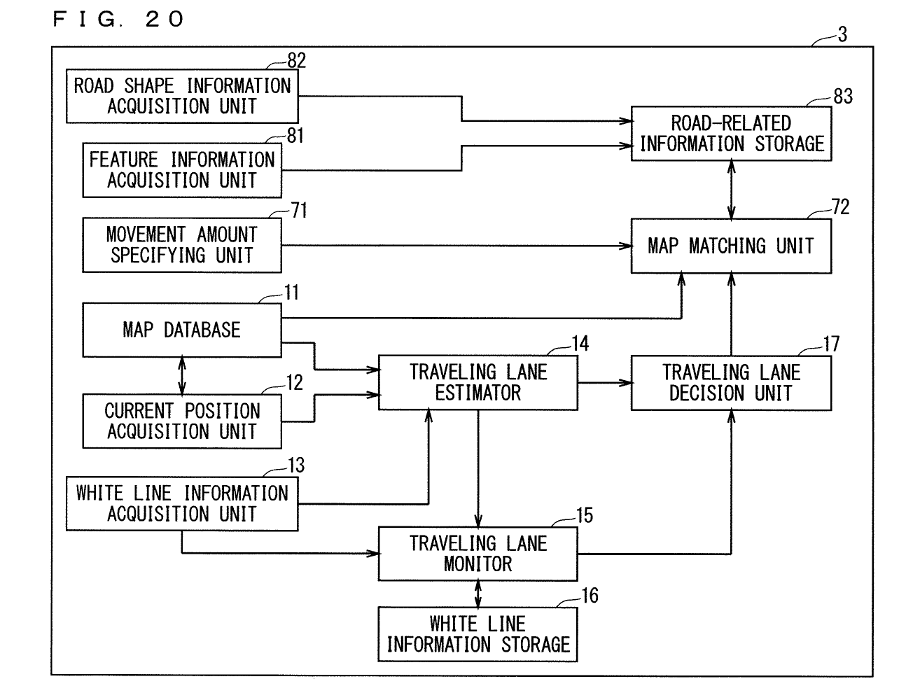

FIG. 20 is a block diagram showing a configuration of a traveling lane determining device 3 in a third embodiment of the present invention. The traveling lane determining device 3 of this embodiment includes the same constituents as those of the traveling lane determining device 1 of the first embodiment and the traveling lane determining device 2 of the second embodiment, and accordingly, the same reference numerals are assigned to the same constituents, and a common description is omitted.

In a similar way to the first embodiment and the second embodiment, the traveling lane determining device 3 of this embodiment is configured to be mountable on a vehicle, for example, an automobile. Moreover, in this embodiment, the traveling lane determining device 3 is realized by a navigation device having a navigation function to guide a route. A traveling lane determining method as another embodiment of the present invention is executed by the traveling lane determining device 3 of this embodiment.

The traveling lane determining device 3 is configured by further including a feature information acquisition unit 81, a road shape information acquisition unit 82, and a road-related information storage 83 in addition to the configuration of the traveling lane determining device 2 of the second embodiment. That is, the traveling lane determining device 3 is configured by including the map database 11, the current position acquisition unit 12, the white line information acquisition unit 13, the traveling lane estimator 14, the traveling lane monitor 15, the white line information storage 16, the traveling lane decision unit 17, the movement amount specifying unit 71, the map matching unit 72, the feature information acquisition unit 81, the road shape information acquisition unit 82, and the road-related information storage 83.

The feature information acquisition unit 81 is configured of a front camera provided so as to be capable of capturing a front of the vehicle in the traveling direction, a rear camera provided so as to be capable of capturing a rear of the vehicle in the traveling direction, and sensors such as laser radars. The feature information acquisition unit 81 acquires feature information on a feature installed on a road, such as a sign, a temporary stop line, a pedestrian crossing and a guardrail on the road on which the vehicle is traveling. The feature information acquisition unit 81 stores the acquired feature information in the road-related information storage 83.

The road shape information acquisition unit 82 is configured of sensors such as a gyro sensor, an inclination sensor, a laser radar and a camera. The road shape information acquisition unit 82 acquires road shape information including information indicating a longitudinal gradient (hereinafter referred to as “inclination” in some cases) of the road on which the vehicle is traveling, information indicating a cross gradient (hereinafter referred to as “cant bank” in some cases) of the road on which the vehicle is traveling, and information indicating a curve curvature of the road on which the vehicle is traveling. The road shape information acquisition unit 82 acquires the road shape information in consideration of the inclination and orientation of the vehicle. The road shape information acquisition unit 82 stores the acquired road shape information in the road-related information storage 83.

The road-related information storage 83 is realized by a storage device such as a semiconductor memory. The road-related information storage 83 stores the feature information given from the feature information acquisition unit 81 and the road shape information given from the road shape information acquisition unit 82. The road-related information storage 83 stores the feature information acquired by the feature information acquisition unit 81 within a predetermined time (hereinafter referred to as “prescribed time” in some cases) and the road shape information acquired by the road shape information acquisition unit 82 within the predetermined time.

A hardware configuration of the traveling lane determining device 3 in this embodiment is similar to the hardware configuration of the traveling lane determining device 1 shown in FIG. 2, and accordingly, illustration and a common description will be omitted. In a similar way to the traveling lane determining device 1 shown in FIG. 2, the traveling lane determining device 3 is configured by including at least a processing circuit, a memory and an input/output interface.

Respective functions of the feature information acquisition unit 81 and the road shape information acquisition unit 82 in the traveling lane determining device 3 are realized by the processing circuit. That is, the traveling lane determining device 3 includes the processing circuit for acquiring the feature information by the feature information acquisition unit 81, and for acquiring the road shape information by the road shape information acquisition unit 82.

The functions of the feature information acquisition unit 81 and the road shape information acquisition unit 82 in the traveling lane determining device 3 are realized by software, firmware, or a combination of the software and the firmware. The software and the firmware are described as programs, and are stored in the memory.

The processing circuit reads out and executes the programs stored in the memory, thereby realizing the functions of the respective sections of the feature information acquisition unit 81 and the road shape information acquisition unit 82. That is, the traveling lane determining device 3 includes the memory for storing such a program in which, at a time of being executed by the processing circuit, a step of acquiring the feature information by the feature information acquisition unit 81 and a step of acquiring the road shape information by the road shape information acquisition unit 82 are executed consequently.

Moreover, this program can also be said to be that which causes a computer to execute a procedure and method of the processing performed by the feature information acquisition unit 81 and the road shape information acquisition unit 82 in the traveling lane determining device 3.

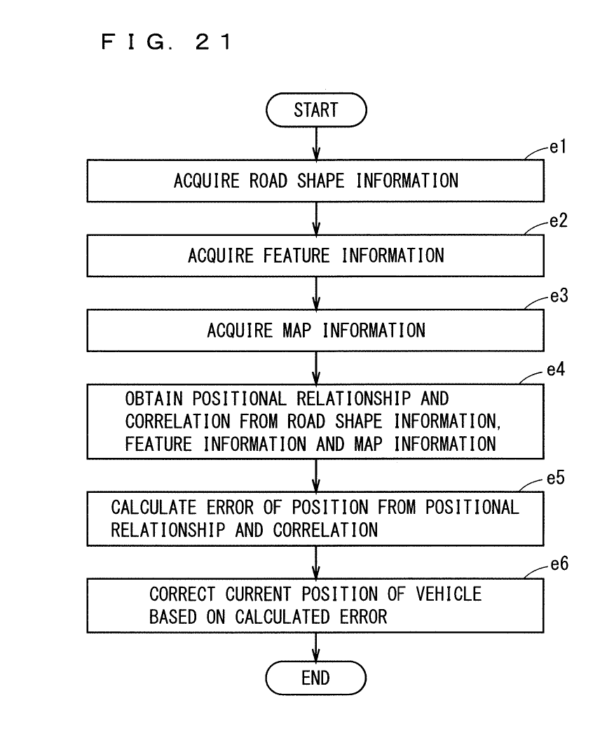

FIG. 21 is a flowchart showing a processing procedure with regard to error correction processing in the traveling lane determining device 3 of the third embodiment of the present invention. Respective processes of the flowchart shown in FIG. 21 are executed by the map matching unit 72. The flowchart shown in FIG. 21 is started when the power supply of the traveling lane determining device 3 is turned on, or is started every predetermined cycle, and the processing proceeds to Step e1.

In Step e1, the map matching unit 72 acquires the road shape information from the road-related information storage 83. When the process of Step e1 is ended, the processing proceeds to Step e2.

In Step e2, the map matching unit 72 acquires the feature information from the road-related information storage 83. When the process of Step e2 is ended, the processing proceeds to Step e3.

In Step e3, the map matching unit 72 acquires the map information from the map database 11. When the process of Step e3 is ended, the processing proceeds to Step e4.

In Step e4, from the road shape information acquired in Step e1, the feature information acquired in Step e2, and the map information acquired in Step e3, the map matching unit 72 obtains a positional relationship and a correlation between the detected road shape and feature and the road shape and the feature, which are based on the map information. When the process of Step e4 is ended, the processing proceeds to Step e5.

In Step e5, from the positional relationship and the correlation between the detected road shape and feature and the road shape and the feature, which are based on the map information, the positional relationship and the correlation being obtained in Step e4, the map matching unit 72 calculates an error of a position detected as the current position of the vehicle. When the process of Step 35 is ended, the processing proceeds to Step e6.

In Step e6, the map matching unit 72 corrects the current position of the vehicle based on the error calculated in Step e5. When the process of Step e6 is ended, all the processing procedure of FIG. 21 is ended.

As described above, in accordance with this embodiment, the error of the position of the vehicle with respect to the traveling direction of the vehicle is corrected by the map matching unit 72 based on the correlation between the road shape such as a gradient and a curvature, which are obtained by the road shape information acquisition unit 82 configured of the sensor and the like, and the road shape such as a gradient and curvature of the road, which are based on the map information, and based on the relationship between the position of the feature, which is acquired by the feature information acquisition unit 81 configured of the sensor and the like, and the position of the feature, which is based on the map information. In this way, the current position of the vehicle can be specified with relatively high accuracy.

The traveling lane determining devices 1 to 3 of the respective embodiments described above can be applied not only to the navigation device mountable on the vehicle but also to a system in which a communication terminal device, a server device and the like are appropriately combined with one another. The communication terminal device is, for example, a PND (Portable Navigation Device) or a portable communication device, which has a function to communicate with the server device. The portable communication device is, for example, a mobile phone, a smartphone, and a tablet-type terminal device.

When the system is constructed by appropriately combining the navigation device, the communication terminal device and the server device with one another as described above, the constituent elements of each of the traveling lane determining devices 1 to 3 according to the respective embodiments may be dispersedly disposed in the respective devices which constitute the system, or may be cocentratedly disposed in any of the devices.

No matter whether the respective constituent elements of each of the traveling lane determining devices 1 to 3 of the embodiments are dispersedly disposed as described above in the respective devices which constitute the above-described system or cocentratedly disposed as described above in any of the devices, similar effects to those in the above-mentioned respective embodiments can be obtained.

The above-mentioned respective embodiments and modification examples thereof are merely illustrations of the present invention, and the respective embodiments and the modification examples thereof can be freely combined with one another within the scope of the present invention. Moreover, arbitrary constituent elements of the respective embodiments and the modification examples thereof can be appropriately changed or omitted.

Although the present invention has been described in detail, the above description is illustration in all aspects, and the present invention is not limited to this. It is interpreted that innumerable modification examples, which are not illustrated, are conceivable without departing from the scope of the present invention.

### REFERENCE SIGNS LIST

1, 2, 3: Traveling lane determining device
11: Map database
12: Current position acquisition unit
13: White line information acquisition unit
14: Traveling lane estimator
15: Traveling lane monitor
16: White line information storage
17: Traveling lane decision unit
21: Processing circuit
22: Memory
23: Input/output interface
31, 31a, 31b, 31c, 31d, 31e, 31f, 41, 42, 43, 44, 45, 46: Vehicle
71: Movement amount specifying unit
72: Map matching unit
81: Feature information acquisition unit
82: Road shape information acquisition unit
83: Road-related information storage

1-10. (canceled)

11. A traveling lane determining device that determines a traveling lane as a lane on which a vehicle is traveling among lanes which constitute a road, the traveling lane determining device comprising:
a processor to execute a program; and
a memory to store the program which, when executed by the processor, performs processes of:
storing map information on a map including said road;
acquiring current position information on a current position of said vehicle;
acquiring white line information on a white line that divides said road;
storing said white line information;
estimating said traveling lane on which said vehicle is traveling based on said map information, said current position information and said white line information;
monitoring said traveling lane estimated; and
deciding said traveling lane based on a result of said estimating and a result of said monitoring,
wherein in said estimating,
a total probability that said vehicle is traveling each of said lanes is calculated based on a probability that each of said lanes, which constitutes said road, is said traveling lane, the probability being obtained based on a line type of said white line, a probability that each of said lanes is said traveling lane, the probability being obtained based on whether or not a lane adjacent to said current position of said vehicle is present, and a probability that each of said lanes is said traveling lane, the probability being obtained based on a lane on which said vehicle traveled when said traveling lane was previously estimated, and one of said lanes whose total probability is largest is estimated as said traveling lane.

12. The traveling lane determining device according to claim 11, wherein, when number-of-lanes information that indicates the number of said lanes cannot be acquired from said map information, said processor estimates the number of said lanes based on the probability that each of said lanes is said traveling lane, the probability being obtained based on whether or not the lane adjacent to said current position of said vehicle is present, and the number of times that said vehicle changed the lane on which said vehicle traveled which is determined based on the number of times that said vehicle crosses said white line, and estimates said traveling lane based on the estimated number of said lanes.

13. The traveling lane determining device according to claim 11, wherein, when said white line information, which is same, is continuously acquired, said processor estimates said traveling lane based on the probability that each of said lanes is said traveling lane, the probability being obtained based on whether or not the lane adjacent to said current position of said vehicle is present, and the probability that each of said lanes is said traveling lane, the probability being obtained based on the lane on which said vehicle traveled when said traveling lane was previously estimated.

14. The traveling lane determining device according to claim 11, wherein, when a probability that a lane different from the lane estimated as said traveling lane is said traveling lane exceeds a predetermined threshold value after estimating said traveling lane, said processor updates said traveling lane to said different lane.

15. The traveling lane determining device according to claim 11, wherein, when it is determined that said white line has been crossed from a temporal change of said white line information, said processor newly estimates said traveling lane.

16. The traveling lane determining device according to claim 11, wherein, based on a lane width of each of said lanes predicted from said white line information, said line type of said white line of said lane, and information on vehicles surrounding said vehicle, said processor predicts whether or not said adjacent lane is present, and based on a result of the prediction, obtains a probability that each of said lanes is said traveling lane, the probability being obtained based on whether or not the lane adjacent to said current position of said vehicle is present.

17. The traveling lane determining device according to claim 11, wherein, when the number of times that said vehicle changed the lane on which said vehicle traveled, the number being obtained from said white line information, is larger than the number of said lanes, the number being obtained from said map information, said processor determines that said map information is wrong, and estimates said traveling lane.

18. The traveling lane determining device according to claim 11, wherein said processor further performs processes of:
specifying a movement amount of said vehicle; and
map matching for specifying, based on traveling lane information indicating said traveling lane decided, and based on movement amount information indicating said movement amount specified, a position of said vehicle on said map that is based on said map information.

19. The traveling lane determining device according to claim 18, wherein said processor further performs processes of:
acquiring road shape information on a shape of said road; and
acquiring feature information on a feature installed on said road,
wherein said map matching includes correcting an error of a position of said vehicle with respect to a traveling direction of said vehicle based on a correlation between the shape of said road, the shape being based on said road shape information, and a shape of said road, the shape being based on said map information, and based on a relationship between a position of said feature, the position being based on said feature information, and a position of said feature, the position being based on said map information.

20. A traveling lane determining method for determining a traveling lane as a lane on which a vehicle is traveling among lanes which constitute a road, the traveling lane determining method comprising:
acquiring current position information on a current position of said vehicle;
acquiring white line information on a white line that divides said road;
estimating the traveling lane on which said vehicle is traveling based on map information on a map including said road, said current position information and said white line information;
monitoring said estimated traveling lane; and
deciding said traveling lane based on a result of said estimating and a result of said monitoring,
wherein, at a time of estimating said traveling lane,
a total probability that said vehicle is traveling each of said lanes is calculated based on a probability that each of lanes, which constitutes said road, is said traveling lane, the probability being obtained based on a line type of said white line, a probability that each of said lanes is said traveling lane, the probability being obtained based on whether or not a lane adjacent to said current position of said vehicle is present, and a probability that each of said lanes is said traveling lane, the probability being obtained based on a lane on which said vehicle traveled when said traveling lane was previously estimated, and one of said lanes whose total probability is largest is estimated as said traveling lane.
